(19) United States
(12) Patent Application Publication
(10) Pub. No.: US 2010/0154934 A1
(43) Pub. Date: Jun. 24, 2010

(54) APPARATUS AND METHODS FOR SHAPING AND MACHINING ELONGATE WORKPIECES

(76) Inventors: J. Melvon Hatch, JR., Taylorsville, UT (US); Jeff Hatch, West Jordan, UT (US)

Correspondence Address: TRASKBRITT, P.C., P.O. BOX 2550, SALT LAKE CITY, UT, 84110, US

(21) Appl. No.: 12/544,162

(22) Filed: Aug. 19, 2009

Related U.S. Application Data
(60) Provisional application No. 61/090,183, filed on Aug. 19, 2008.
(60) Provisional application No. 61/090,228, filed on Aug. 19, 2008.

(51) Int. Cl. B27M 1/08; B27M 1/00; B27C 9/00

(52) U.S. Cl. 144/363; 144/329; 144/1.1

(57) ABSTRACT

The present invention includes methods in which work pieces are machined based upon the appearance of their surfaces. The work piece may be processed in such a way that surfaces with desirable features may be oriented so as to form visible surfaces of a finished part. In addition, the present invention includes woodworking machines that define joint features in and shape surfaces of rough work pieces.

### CROSS-REFERENCE TO RELATED APPLICATION

A claim for priority is made to U.S. Provisional Patent Application Ser. No. 61/090,183, filed on Aug. 19, 2008, and to U.S. Provisional Patent Application Ser. No. 61/090,228, the entire disclosures of both of which are hereby incorporated herein by this reference.

### TECHNICAL FIELD

The present invention relates generally to machines for shaping, machining, and optionally sanding elongate work pieces, such as pieces of wood. More specifically, the present invention relates to machines that enable the inspection of rough elongate work pieces prior to shaping, machining, and optionally sanding the work pieces so that imperfections in the work pieces may be oriented at less visible locations or at locations from which imperfections may be removed during shaping processes.

### RELATED ART

The face frames of doors, including cabinet doors, include assemblies of elongate members. The vertically oriented members of a face frame are referred to as “stiles,” while the horizontally oriented members of a face frame are called “rails.” These elongate members are typically formed by cutting lengths from a longer, premolded, or preshaped, work piece. The shorter lengths are then molded, or shaped, and sanded using a variety of separate, specialized machines.

Conventionally, elongate work pieces have been processed by a number of separate machines to manufacture frame members and their interconnection features; e.g., mortises and tenons. For example, a long, elongate work piece from which several smaller elongate work pieces would ultimately be cut has first been run through a “molder.” Typically, the long, elongate work piece is processed by the molder without considering the locations of any defects of the long, elongate work piece. Consequently, imperfections, such as knots, holes, or the like, are likely to appear on all surfaces of the long, elongate work piece, including surfaces that will be visible in the finished parts. When the presence of imperfections at such locations is undesirable, a significant portion of the elongate work piece may ultimately be removed and discarded. This problem is further amplified when the molded, long, elongate work piece is cut into smaller elongate work pieces of desired length without intermediate inspection processes (e.g., by automated saws). Ultimately, quality control processes often result in the disposal and, thus, wastage, of entire smaller elongate work pieces.

A third machine may be used to form mortises in some of the work pieces (e.g., in stiles, etc.). Yet another machine may be required to form tenons and, optionally, haunches (which are features that may be associated with tenons to prevent loosening of the tenons from their corresponding mortises) from others of the work pieces (e.g., in rails, etc.).

While existing processes for shaping and sanding elongate work pieces have worked quite well for a long time, they are undesirable for a number of reasons. As indicated previously, existing processes often waste large amounts of material. It has been estimated that when existing technologies are used to form rails and stiles, as much as thirty percent (30%) or more of the material may be wasted. In addition, a large number of separate, expensive machines is typically required to mold a long, elongate work piece, cut the long, elongate work piece into shorter elongate work pieces, and to form joint features from the shorter elongate work pieces.

### SUMMARY

The present invention includes methods and apparatus for manufacturing products from wood or similar materials. More specifically, the present invention includes apparatus and methods for manufacturing parts that are secured to one another with mortise and tenon joints, such as the rails and stiles of a door frame, a window frame, a cabinet face frame, a cabinet door frame, or the like.

In a more specific aspect, the present invention includes embodiments of woodworking processes that enable the inspection and orientation of rough elongate work pieces before they are shaped and optionally sanded. In some embodiments, a rough elongate work piece may be inspected before it is cut to size from a longer work piece, which may facilitate the avoidance of imperfections in the rough elongate work piece that is cut from the longer work piece. Alternatively, or in addition to inspecting the longer work piece prior to cutting the rough elongate work piece therefrom, the rough elongate work piece may be inspected after it has been cut from a longer work piece. Inspection of the rough elongate work piece may enable orientation of the work piece in such a way that imperfections may be removed during the shaping and/or sanding processes, or their visibility in the finished product may be minimized.

In another aspect, the present invention includes various embodiments of machines that are configured to retain an elongate work piece in a selected orientation relative to a support while at least one elongate edge and at least one end of the elongate work piece is shaped and optionally. Such a machine may be configured to retain the elongate work piece in the selected orientation as each elongate edge, end, and major surface of the elongate work piece is shaped and optionally sanded.

Other aspects, as well as various features and advantages, of the present invention will become apparent to those of skill in the art through consideration of the ensuing description, the accompanying drawings, and the appended claims.

### BRIEF DESCRIPTION OF THE DRAWINGS

In the drawings:

FIG. 1 is a front view of an embodiment of woodworking machine according to the present invention;

FIG. 2 is a rear view of the embodiment of woodworking machine shown in FIG. 1;

FIG. 3 is a top view of a the embodiment of woodworking machine depicted by FIGS. 1 and 2;

FIG. 4 is a perspective view of an embodiment of tool assembly that may be included in a woodworking machine according to various embodiments of the present invention;

FIG. 5 is a top view of another embodiment of tool assembly;

FIGS. 6 and 7 are schematic representations of other embodiments of woodworking machines of the present invention;

FIG. 8 is an embodiment of defect minimization element that may be included in a woodworking machine according to embodiments of the present invention;

FIG. 9 shows a long, elongate work piece;

FIG. 10 shows a shorter elongate work piece that has been cut from the long, elongate work piece of FIG. 9 with surfaces that have been designated based on an exterior appearances thereof, in accordance with an embodiment of a work piece processing method of the present invention;

FIGS. 11 and 12 schematically depict processing of ends of a shorter elongate work piece in accordance with an embodiment of a work piece processing method that incorporates teachings of the present invention;

FIGS. 13 and 14 schematically depict processing of edges and major surfaces of a shorter elongate work piece in accordance with an embodiment of a work piece processing method according to the present invention;

FIG. 15 depicts an example of end features that may be formed from ends of a shorter elongate work piece that has been processed in accordance with teachings of the present invention;

FIG. 16 depicts an example of edge features that may be formed in edges of a shorter elongate work piece that has been processed in accordance with teachings of the present invention;

FIG. 17 depicts an embodiment of customizable curve according to the present invention; and

FIG. 18 illustrates another embodiment of customizable curve of the present invention.

### DETAILED DESCRIPTION

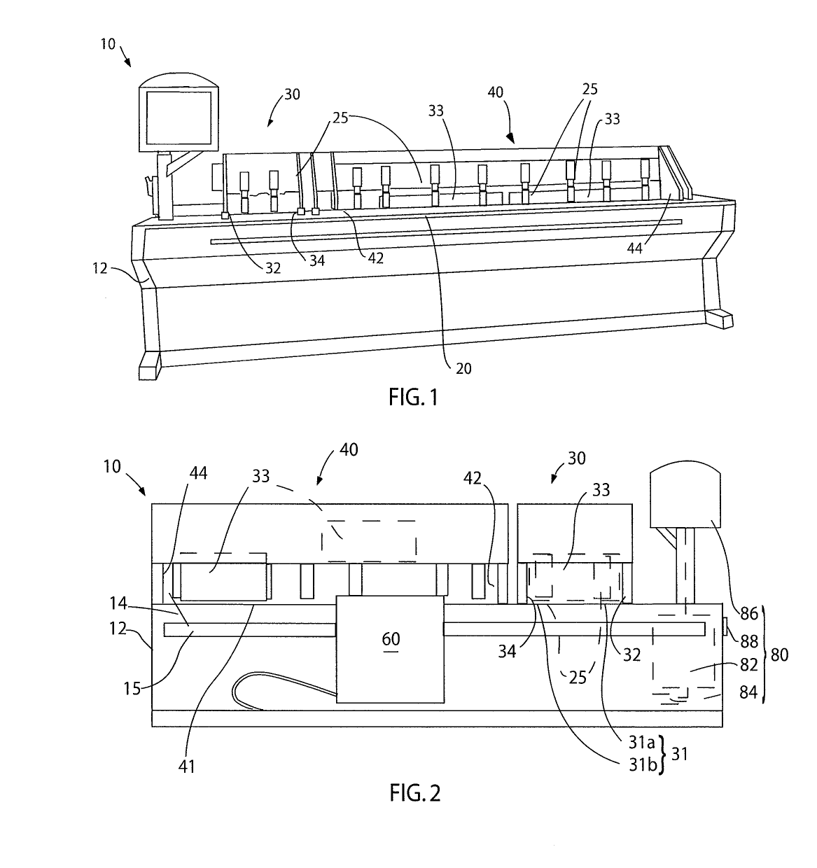

Various aspects of the present invention will be described with respect to an embodiment of a woodworking machine 10, an embodiment of which is depicted by FIGS. 1 through 3. Various embodiments of woodworking machine 10 are configured to form the members of frames (i.e., stiles and rails) for cabinet face frames, cabinet doors, doors, windows, and other similar articles of manufacture. More specifically, woodworking machine 10 may form joints (e.g., mortise and tenon joints, dowel holes, etc., with optional haunches) for securing frame members to one another, as well as joints (e.g., grooves, toungues, etc.) for engaging (e.g., receiving, being received by, etc.) other elements (e.g., panels) of the article of manufacture. In addition to machining joints from work pieces, some embodiments of woodworking machine 10 define the shapes, including decorative configurations, from work pieces.

As shown, woodworking machine 10 includes a frame 12 that carries other features of woodworking machine 10. Such other features include, but are not limited to, a support 20, one or more clamps 25, a tool carriage 60 and associated elements, including tools, and a controller 80.

In one embodiment, the support 20 of woodworking machine 10 includes a flat surface with a number of separate zones 30, 40, etc., at which different machining processes are effected. Each zone 30, 40, etc., may be accessible by an individual who operates or otherwise uses woodworking machine 10 or by automated equipment that handles and transports work pieces. Each zone 30, 40, etc., includes a working edge 31, 41, etc., located adjacent and, optionally, parallel to a tool path 62, along which tool assembly 60 may travel. In addition, at least one side fence 32, 42, etc., may be located along at least one side of each zone 30, 40, etc. In some embodiments, a pair of opposed side fences 32 and 34, 42 and 44, etc., may be positioned adjacent to opposite sides of one or more zones 30, 40, etc.

In the depicted embodiment, zone 30 is defined by side fences 32 and 24, and occupies a relatively small area of support 20. At zone 30, one or both ends of a work piece may be processed. In a more specific embodiment, a location of side fence 32 may position a work piece such that a first end of the work piece, when positioned adjacent to a particular location 31b of working edge 31, may be machined or otherwise processed (e.g., to form a tenon, haunch, etc., therefrom) by a tool of tool assembly 60. In some even more specific embodiments, another side fence 34 of zone 30 may be located so as to position a second end of a work piece adjacent to another location 31b of working edge 31. Such a configuration may optimize use of tool assembly 60 by enabling tool assembly 60 to move back and forth between location 31a and 31b. While tool assembly 60 is used to process a work piece at one location 31a, 31b, another work piece may be removed from and/or replaced at the other location 31b, 31a.

Zone 40 on support 20 of the depicted embodiment of woodworking machine 10 is configured to receive and orient work pieces in such a way as to facilitate machining or other processing of the longer edges and/or surfaces of the work pieces. As the long edges and/or surfaces of work pieces are processed in the depicted embodiment of zone 40, the depicted embodiment zone 40 has a width that will accommodate the entire lengths of the work pieces. In a particular embodiment, the width of zone 40 may accommodate work pieces of up to about 120 inches in length, although larger and smaller zone 40 widths are also within the scope of the present invention.

Zone 40 may include at least one side fence 42, 44 that serves as a reference point for tool assembly 60 and, thus, places a work piece at a desired location along working edge 41 of zone 40. In some embodiments where a zone 40 includes opposed side fences 42 and 44, at least one of the side fences 42, 44 may move laterally relative to working edge 41 (i.e., along the x-axis). A moveable side fence 42, 44 may enable adjustment of the size of zone 40 for use with work pieces of different dimensions (e.g., different lengths, etc.). As an example, a width of zone 40 may be sized to dimensions that are the same as or slightly larger than the length of a work piece, which may facilitate accurate positioning of the work piece along working edge 41 when an edge or surface of the work piece is to be processed. When a work piece is accurately positioned along working edge 41, features (e.g., that are to be formed in the work piece, etc.) may be accurately positioned along the length of the work piece.

Some embodiments of woodworking machines 10 that incorporate teachings of the present invention may include additional zones. As a nonlimiting example, a particular embodiment of woodworking machine 10′ may include another zone 40, as depicted by FIG. 6. With two zones 40, a woodworking machine 10′ may accommodate two or more frame members (e.g., two rails, two stiles, a rail and a stile, etc.) at the same time. In embodiments where the zones 40 accommodate the same type of part (e.g., rails, stiles, etc.), the additional zone 40 facilitates the removal and replacement of one rail or stile from one zone 40 while another rail or stile is being processed at another zone 40, and optimizes use of a tool assembly 60 that machines or otherwise processes the long edges and/or surfaces of a work piece.

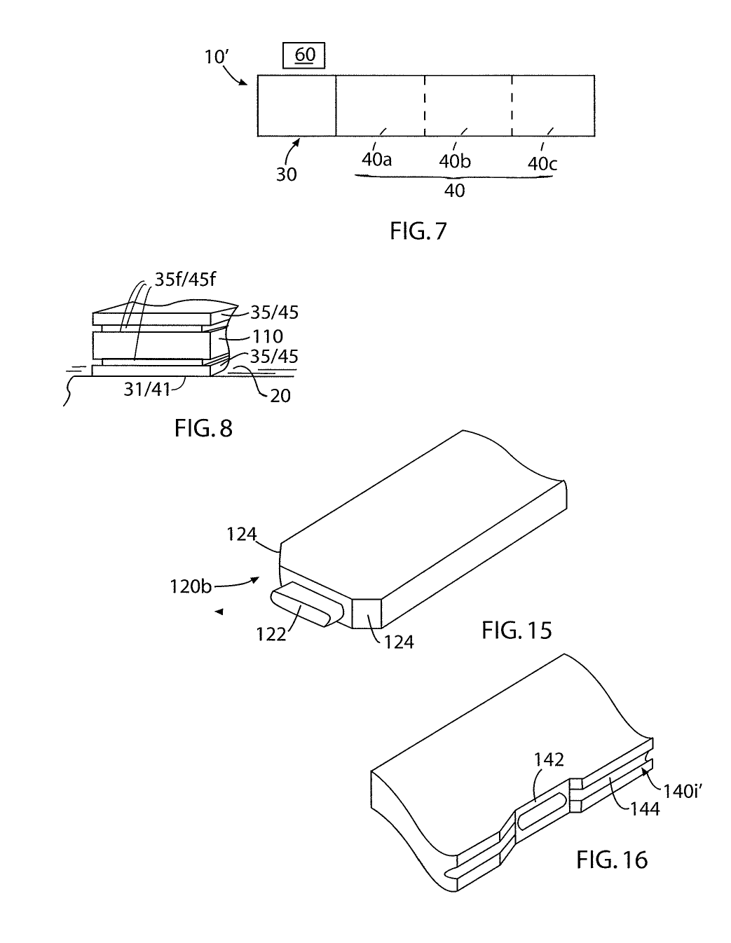

In other embodiments, such as that shown in FIG. 7, a woodworking machine 10″ with a single, large zone 40, which is configured to accommodate large (e.g., long, etc.) work pieces, may be subdivided (e.g., by the addition of side fences at intermediate locations, etc.) into two or more smaller subzones 40a, 40b, etc., when smaller work pieces are to be processed.

Referring again to FIGS. 1 through 3, at least one clamp 25 is associated with each zone 30, 40, etc., or each potential subzone 40a, 40b, etc. (FIG. 6). Each clamp 25 is configured to hold a work piece in a stationary position relative to support 20. Clamp 25 may, as illustrated, include a piston (e.g., a piston driven by a motor, a pneumatically operated piston, a hydraulically operated piston, etc.). Once a work piece is positioned in a desired orientation against support 20, between support 20 and clamp 25, clamp 25 may be pressed (e.g., moved downward, etc.) against the work piece with sufficient force to hold the work piece in the desired position and orientation while the work piece is machined or otherwise processed. Once the desired processing of the work piece is complete, clamp 25 may be moved away from the work piece to release the same, enabling repositioning and/or reorientation, as well as movement of the work piece.

At least one stop 33 may also be associated with each zone 30, 40, etc., or each potential subzone 40a, 40b, etc. (FIG. 7). In the depicted embodiment, each stop 33 is a rear fence, or back fence, located laterally beyond working edge 31, 41, etc., of each zone 30, 40, etc. Stop 33 may be positioned a predetermined lateral distance beyond (i.e., in the z-axis direction from) working edge 31, 41, etc. The predetermined lateral distance between stop 33 and working edge 31, 41, etc., may be fixed or adjustable. In embodiments where the lateral distance between stop 33 and working edge 31, 41, etc., is adjustable, the position of stop 33 relative to working edge 31, 41, etc., may be varied to tailor the distance that a work piece end, edge, or surface to be processed overhangs, or extends laterally beyond working edge 31, 41, etc. By way of nonlimiting example, the position of a stop 33 relative to its corresponding working edge 31, 41, etc, may be controlled to allow for different haunch depths, while maximizing the area of a work piece that is held by support 20.

Each stop 33 may have a “closed” position (down in the depicted embodiment) and an “open” position (up the in the depicted embodiment). While in the “closed” position, a work piece may be positioned on support with an end, edge, or surface that is to be processed abutting stop 33. Once the work piece is in position, one or more clamps 25 may be forced against the work piece to maintain its position and orientation against support 20. Stop 33 may then be moved to the “open” position, exposing the end, edge, or surface of the work piece to the tools of tool assembly 60.

Turning now to FIG. 8, a defect minimization element 35, 45, etc., may be associated with one or more working edges 31, 41, etc., of support 20 of woodworking machine 10. In some embodiments, defect minimization element 35, 45, etc., comprises a block or strip of a suitable material (e.g., a suitable plastic, such as polyoxymethylene (available under the trade name DELRIN® from E.I. du Pont de Nemours and Co. of Wilmington, Del.), wood, etc.) that has been secured in place upon or adjacent to support 20 relative to a corresponding working edge 31, 41, etc. In other embodiments, defect minimization elements 35, 45, etc., are separate elements that are placed against at least one surface of a work piece and positioned upon support 20 along with the work piece.

Each defect minimization element 35, 45, etc., is configured to reduce or eliminate the generation of defects (e.g., fray, which includes small pieces of material that may protrude from a newly formed corner of a processed work piece; tear-outs, which include the undesired removal of material from the surfaces of a work piece; etc.) as a work piece is processed. In this regard, a defect minimization element 35, 45, etc., may include one or more surface features 35f, 45f, etc., to which a tool of tool assembly 60 will come in close proximity as the work piece is processed. In some embodiments, surface features 35f, 45f, etc., may have initially been defined by one or more tools of tool assembly 60 operating under control of programming of controller 80 of woodworking machine 10.

In use, an end, edge, or surface of a work piece is positioned against a support surface of the defect minimization element 35, 45, etc., as that end, edge, or surface of the work piece is machined or otherwise processed. Features 35f, 45f, etc., of defect minimization element 35, 45, etc., may initially be recessed relative to the end, edge, or surface of the work piece that is to be processed. Since one or more tools of tool assembly 60 will come into close proximity to each recessed feature 35f, 45f, etc., each recessed feature 35f, 45f, etc., may prevent the generation of fray at supported corners of the work piece by eliminating space in which material could otherwise be forced away from tools of tool assembly 60 as the work piece is processed (i.e., substantially all of the material remains in the path of one or more operating tools).

FIGS. 4 and 5 show features of a tool assembly 60 of an embodiment of woodworking machine according to the present invention. As illustrated, tool assembly 60 may include a carriage 62, a plurality of spindles 70a, 70b, etc., (each of which may also be referred to herein as a “spindle 70”) held by carriage 62, and a tool 72a, 72b, etc., (each of which may also be referred to herein as a “tool 72”) associated with and operated by each spindle 70a, 70b, etc. Tools 72 may be oriented horizontally (i.e., parallel to a plane in which a supported surface of a work piece resides), vertically (i.e., perpendicular to a plane in which a supported surface of a work piece resides), or tool assembly 60 may include some tools 72 that are horizontally oriented and other tools 72 that are vertically oriented.

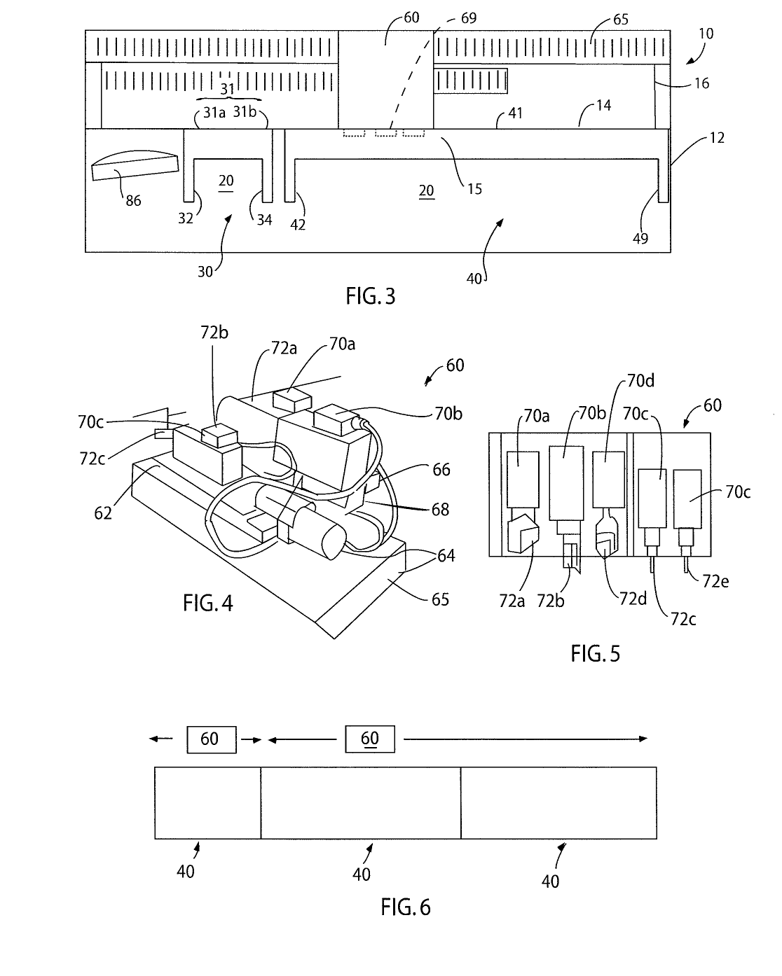

Referring to FIG. 4, carriage 62 includes an x-axis control element 64, a y-axis control element 66, and a z-axis control element 68. x-axis control element 64 moves carriage 62 along working edges 31, 41, etc., of support 20. In some embodiments, x-axis control element 64 includes a motor-controlled rack and pinion system, in which the rack 65 (FIG. 3) is supported by frame 12. Movement of carriage 62 and, thus, of tools 72a, 72b, etc., (or, optionally, movement of tools 72a, 72b, etc., individually of one another) along the y-axis and the z-axis is effected by y-axis control element 66 and z-axis control element 68, respectively. In some embodiments, one or both of y-axis control element 66 and z-axis control element 68 includes a motor and a rotary ball screw associated with the motor, in a manner known in the art.

In the depicted embodiment, x-axis control element 64 includes a pinion that corresponds to and is carried by a rack 65 supported by a base 16 (FIGS. 2 and 3) extending outwardly beyond a back side 14 of frame 12. Thus, x-axis control element 64 may only support the back side of carriage 62. In such an embodiment, an additional support element 69 (FIG. 3) may support a front side of carriage 62. In some embodiments, additional support element 69 is associated with a back side 14 of frame 12 (i.e., the side of frame 12 adjacent to which working edges 31, 41, etc., are located), which extends downwardly from support 20 to base 16. In a specific embodiment, additional support element includes one or more engagement features (e.g., wheels, pinions, etc.) that travel along a track 15 (FIGS. 2 and 3) extending along back side 14 of frame 12.

In the embodiment illustrated by FIG. 4, carriage 62 holds three tools 72a, 72b, 72c and their corresponding spindles 70a, 70b, and 70c, respectively. In a specific embodiment, tool 72a may be a mortise tool, tool 72b may be a tenon tool, and tool 72c may be a haunch tool. In an even more specific embodiment, one or both of tenon tool 72b and haunch tool 72c may comprise carbide inserts. Spindle 70a, which drives mortise tool 72a, may comprise a three horse power (hp) high-frequency spindle of a type known in the art, while spindle 70b, which operates tenon tool 72b, may comprise a six horse power high-frequency spindle of a type known in the art, and spindle 70c, which controls haunch tool 70c, may comprise a five horse power high-torque spindle of a type known in the art.

Carriage 62, in various embodiments, such as that shown in FIG. 5, may also hold one or more additional tools 72d, 72e, etc., and their associated spindles 70d, 70e, etc. Without limiting the scope of the present invention, such additional tools 72d, 72e, etc., may include one or more tools for pilot boring, cutting, routing, chamfering, grooving, plowing, and the like. Some of these tools may be useful for molding one or more surfaces of a work piece, or for imparting one or more of the surfaces of the work piece with a desired shape. As another example of an additional tool 72d that may be supported by carriage 62, a counter-rotating cutter may minimize the generation of defects (e.g., fraying, tear-out, etc.) in a work piece that has been machined by a corresponding primary cutter.

FIGS. 1 through 3 depict an embodiment of woodworking machine 10 with a single tool assembly 60 that carries every tool 72a, 72b, etc., of woodworking machine 10. As shown in FIG. 6, the present invention also includes embodiments of woodworking machines 10 with two or more tool assemblies 60. In some embodiments of woodworking machines 10 with multiple tool assemblies 60, each tool assembly may be associated with an individual zone 30, 40, etc., and include tools 72a, 72b, etc., (FIGS. 4 and 5) that are used only in that zone. As an example, one tool assembly 60 associated with a particular zone 30 may includes tools 72b, 72c, etc., for processing the ends of a work piece, while another tool assembly 60 associated with another zone 40 may include tools 72a, 72b, 72c, 72d, 72e, etc., for processing the edges and/or surfaces of the work piece. In other embodiments, each tool assembly 60 of a woodworking machine 10 may include the same, full complement of tools as at least one other tool assembly of that woodworking machine 10.

With returned reference to FIG. 2, controller 80, which is also carried by frame 12, includes at least one processing element 82, such as a computer. Processing element 82 of controller 80 communicates with various other elements of woodworking machine 10 (e.g., clamps 25, stops 33, fences 42, 44, x-axis control element 64, y-axis control element 66, z-axis control element 68, spindles 70a, 70b, etc.), and may control (e.g., synchronize) operation of one or more of these elements under control of programming (e.g., computer-numeric control (CNC) programming, etc.) in a manner known in the art. One or more programs may be stored by memory 84 associated with controller 80. In some embodiments, processing element 82 may also receive feedback from one or more other elements of woodworking machine 10.

Woodworking machine 10 also includes one or more user interface devices 86. Each user interface device 86, such as the touch screen monitor of the depicted embodiment, enables a user to communicate with controller 80; for example, to input work piece dimensions, to select features that are to be formed on a work piece, to input the dimensions of the feature that are to be formed, to select a previously used data set (e.g., dimensions and/or feature types that correspond to a particular part) from memory 84 associated with controller 80, to modify a previously stored data set, to store a new data set, to terminate operation of woodworking machine 10, or the like.

Controller 80 may also include one or more communication elements 88. Without limiting the scope of the present invention, a communication element 88 may be used to expand or vary the programming of processing element 82, to expand or change the memory 84 accessible by processing element 82, to enable diagnosis of controller 80 or of other elements (e.g., elements from which processing element 82 receives feedback) of woodworking machine 10, or for any other suitable purpose.

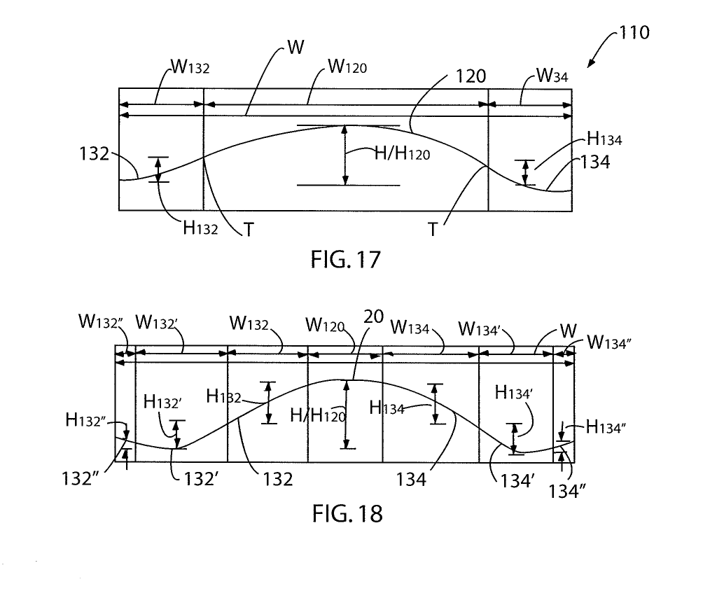

In embodiments of woodworking machine 10 that are configured to machine non-linear (e.g., curved, arched, etc.) work pieces, processing element 82 of controller 80 may be programmed to define features in a manner consistent with the desired shape of the non-linear work piece. In a specific embodiment, processing element 82 may be programmed or configured to operate a program that enables a user to define a customized curve by receiving user inputs. In a more specific embodiment, processing element 82 may display a customizable curve 110, 110′, such as that shown in FIG. 17 or FIG. 18, respectively, as well as information that enables an individual to customize the displayed curve by tailoring or manipulating the various segments of the displayed curve (e.g., by way of a input device of control element 60, such as a touch sensitive monitor, computer mouse, keyboard, etc.).

With reference to FIG. 17, an embodiment of a customizable curve 110 according to the present invention is shown. Customizable curve 110 includes a plurality of segments. In the depicted embodiment, the segments of customizable curve 110 include a central arc 120 and a pair 130 of side arcs 132 and 134. Side arcs 132 and 134 are continuous with opposite sides, or ends 122 and 124, respectively, of central arc 120.

Another embodiment of customizable curve 110′ that includes a plurality of segments is shown in FIG. 18. Like customizable curve 110, the segments of customizable curve 110′ include a central arc 120 with side arcs 132 and 134 on opposite ends 122 and 124 thereof. Customizable curve 110′ also includes two additional pairs 130′ and 130″ of side arcs 132′, 134′ and 132″, 134″, with side arcs 132′ and 132″ positioned on opposite sides of central arc 120 from, and at locations that correspond to the locations of, side arcs 134′ and 134″, respectively. In sequence, from left to right, customizable curve includes side arc 132″, side arc 132′, side arc 132, central arc 120, side arc 134, side arc 134′, and side arc 134″. For the sake of simplicity, each of side arcs 132, 132′, and 132″ may be referred to hereinafter as a “side arc 132” and each of side arcs 134, 134′, and 134″ may be referred to hereinafter as a “side arc 134.”

Of course, customizable curves with different numbers of arcuate segments, as well as customizable curves that includes non-arcuate features between two or more adjacent arcuate segments, are also within the scope of the present invention.

With continued reference to FIGS. 17 and 18, in various embodiments of the present invention, various parameters of a customizable curve 110, 110′ of the present invention may be defined. As an example an overall length L, L′ and height H, H′ of customizable curve 110, 110′ may be set. In addition, relative lengths L₁₂₀, L₁₃₀, L_{130′}, L_{130″} and heights H₁₂₀, H₁₃₀, H_{130′}, H_{130″} of each central arc 120 and side are 132, 134 may be programmed. Such programming may be effected in any suitable manner, such as by entering numeric dimensions into a computer, use of a user manipulatable device (e.g., a a touch-sensitive screen, a computer mouse, etc.) to “drag” dimensional designators (e.g., dimension lines, cross-hairs, points, etc.) to desired locations, or by any other suitable means for defining the overall dimensions of customizable curve 110, 110′, as well as the dimensions of each segment of customizable curve 110, 110′.

The shape of each segment (e.g., of central arc 120) or pair of segments (e.g., each side arc 132, 134) of customizable curve 110, 110′ may also be defined. In some embodiments, the shape of each segment or pair of segments may be selected from a predetermined list of available shapes. In more specific embodiments, each segment may be a circular arc, or it may comprise an arc having one of number of available elliptical, parabolic, or hyperbolic shapes. In other embodiments, the shape of each segment or pair of segments may be user-defined, providing an infinite number of possible arcuate shapes. User-definition of the shape of a particular segment, may be effected by inputting data points into the formula for a particular type of arc (e.g., an elliptical arc, a parabolic arc, an hyberbolic arc, etc.) or by “manipulating” (e.g., by way of a touch sensitive screen, with a computer mouse, etc.) a graphic representation (e.g., an arc displayed on a computer monitor, etc.) of a particular type of arc (e.g., an elliptical arc, a parabolic arc, an hyberbolic arc, etc.), such as by “grabbing” and “dragging” a portion of the displayed arc and moving the same until the displayed arc has the desired shape.

In embodiments where customizable curve 110, 110′ is to be symmetrical, side arcs 132 and 134 may be simultaneously defined.

Transitions T between segments (e.g., between adjacent arcs 120, 132, 134) may also be smoothed. In some embodiments, each transition T may comprise a common point on ends of two adjacent segments. Smoothing of transition T may be effected by modifying the two adjacent segments in such a way that the common end points also share a common tangent. This type of smoothing may occur as an individual generates customizable curve 110, 110′. As an example, once the arcuate shape of a first segment (e.g., of central arc 120) is defined, the available arcuate shapes for adjacent segments (e.g., of side arcs 132 and 134) may be limited to arcuate shapes with end points that will share a common tangent with a tangent to the common end point of the first segment. As another example, as an individual selects a particular arcuate shape for a second segment or for a pair of second segments (e.g., for side arcs 132 and 134), a previously defined arcuate shape of another, first segment (e.g., of center arc 120) or pair of segments may be modified to maintain commonality between tangents to the common end points of the adjacent segments.

In other embodiments, transitions T may comprise “filler elements,” such as straight lines, curves, or discontinuities (e.g., features that are recessed relative to or protrude from customizable curve 110, 110′, etc.), that may be introduced between adjacent segments to produce a visually smooth transition therebetween.

As indicated, the foregoing methods may be embodied as programming of an apparatus that will define a structure that includes a customized curve and/or that will define various features (e.g., joints, mortises, tenons, etc.) along a work piece having the shape of a customized curve. More specifically, the programming may receive user inputs, such as those noted previously herein, that will be used in defining the customized curve. In a specific embodiment, the programming generates computer numeric control (CNC) commands for controlling the operation of tools that remove material from a work piece to define the customized curve and/or to define features along the customized curve.

With returned reference to FIGS. 1 through 3, a woodworking machine 10 according to the present invention may include a number of other components, including safety guards, dust collection apparatus, optical elements, automated handling equipment, and the like.

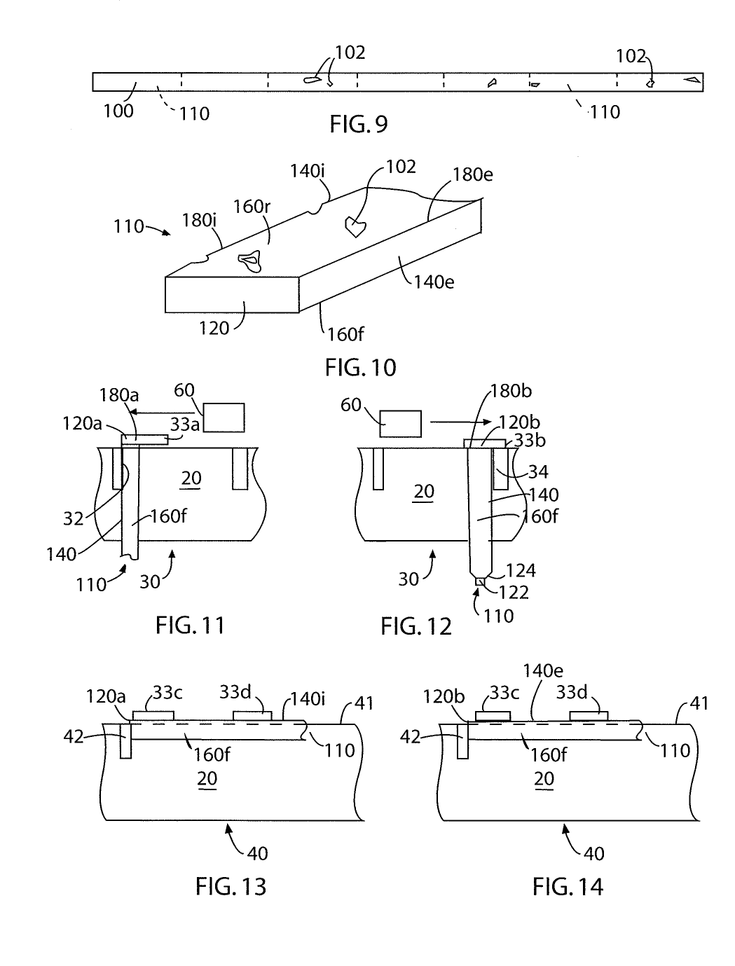

One embodiment of a work piece processing method according to the present invention is depicted by FIGS. 9 through 16. As shown in FIG. 9, a long, elongate work piece 100 is cut into a plurality of shorter elongate work pieces 110 before shaping, or molding, or any other processes (e.g., machining, sanding, etc.) are carried out. In embodiments where the shorter elongate work pieces 110 are pieces of wood, the shorter elongate work pieces 110 will almost inevitably include imperfections 102. The imperfections may include knots, holes, and/or undesirable grain densities. Inspection (e.g., visual inspection, optical inspection, etc.) may accompany cutting of the long, elongate work piece 100 to minimize the presence of defects, such as knots or holes, in each shorter elongate work piece 110. Alternatively, the long, elongate work piece 100 may be cut without any inspection and, thus, without the removal of defects or the consequent disposal of material.

Once the long, elongate work piece 100 has been cut into a number of shorter elongate work pieces 110, the surfaces, including ends 120 (e.g., the surfaces at the ends of a shorter elongate work piece 110 with the smallest areas), edges 140 (e.g., the surfaces on the long sides of each shorter elongate work piece 110), and surfaces 160 (e.g., the major, long surfaces of each shorter elongate work piece 110), of each shorter elongate work piece 110 are inspected and, based upon the relative number of imperfections 102 of each surface, given designations such as “front” (160f) and “rear” (160r) (e.g., for surfaces 160), “interior” (140i) and “exterior” (140e) (e.g., for edges 140), etc., as shown in FIG. 10, that correspond to surfaces of a finished part. Designations may be made on the basis of a particular “look” that is desired for the finished piece. For example, where it is desired that the finished part have a so-called “clear” look, a surface that includes a relatively large number of imperfections 102 or one or more undesirably large imperfections may be designated as a “rear” surface to reduce its visibility when the finished piece is assembled with other finished pieces to form a finished structure. As another example, an edge that includes an undesirably high number of imperfections may be designated as an “interior” edge (i.e., an edge that is to be assembled with or against another member of a finished structure, such as a panel) so that visibility of the imperfections may be reduced when the finished piece is ultimately incorporated into a finished structure or so that the imperfections may be at least partially removed as features are machined into that edge. If a so-called “knotty” appearance is desired, the surfaces of a shorter elongate work piece 110 with knots that will impart the finished part with a desired knotty look may be designated as the “front” surface 160 and/or the “outside” edge 140.

Once surface and edge designations have been made, the shorter elongate work piece 110 may be machined in a manner that corresponds to its designated surfaces and edges. By machining a shorter elongate work piece 110 in this manner, control may be maintained over the appearance of a finished piece. As an example, a shorter elongate work piece 110 may be machined in such a way as to minimize or eliminate the presence of visible imperfections in the finished piece, particularly when the finished work piece 110 is incorporated into a finished structure, such as the frame of a door, window, cabinet face frame, or cabinet door.

In various embodiments of the present invention, the shorter elongate work piece 110 may positioned adjacent to a support (e.g., upon a surface or platen, etc.) of a woodworking machine (e.g., woodworking machine 10, etc.) that will mold, machine, and, optionally, sand each shorter elongate work piece 110 to form a finished part therefrom. In a more specific embodiment, a single woodworking machine may machine some joint features (e.g., tenons 122 (FIG. 15), haunches 124 (FIG. 15), etc.) into ends 120 of each shorter elongate work piece 110, cut grooves 144 (FIG. 16) and other joint features (e.g., mortises 142 (FIG. 16), etc.) into an interior edge 140i of each shorter elongate work piece 110, and shape, or mold, edges 140, surfaces 160, and corners 180 of each shorter elongate work piece 110. In other embodiments, other types of features may be formed in a shorter elongate work piece 110. Examples of such features include, but are not limited to, depressions for hinge attachment, holes for receiving screws, and grooving for receiving other features, such as louvers.

More specifically, with added reference to FIGS. 11 and 12, ends 120 of a shorter elongate work piece 110 may be processed at zone 30. In a specific embodiment, a shorter elongate work piece 110 may be placed in zone 30 of woodworking machine 10 with its rear surface 160r (FIG. 10) against support 20 and an edge 140 against side fence 32 and a first end 120a abutting a stop 33a, as shown in FIG. 11. More specifically, shorter elongate work piece 110 may be oriented in such a way that the surfaces (e.g., surfaces 160, edges 140, etc.) with the least visual appeal will have minimal visibility when a finished part is incorporated into a finished structure (e.g., on a surface that will be located on the interior of a door) and/or so that imperfections are positioned at locations where they will be removed as the shorter elongate work piece 110 is machined.

When shorter elongate work piece 110 is properly positioned against support 20, stop 33a may be moved to enable one or more tools 72 (FIGS. 4 and 5) to access first end 120a. One or more tools 72 may then be brought into contact with first end 120a to process the same. In embodiments where a rail will be formed from shorter elongate work piece 110, tools 72 may define a tenon 122 and haunches 124 from first end 120a (FIG. 12). In embodiments where a stile will be formed from shorter elongate work piece 110, first end 120a and, optionally, a corner 180a between front surface 160f and first end 120a may be shaped, or molded.

That same elongate work piece 110 may then be reoriented within zone 30, as shown in FIG. 12, with rear surface 160r (FIG. 10) still being located against support 20, edge 140 abutting side fence 34, and a second end 120b being placed against another stop 33b. When shorter elongate work piece 110 is properly positioned against support 20, stop 33b may moved to enable one or more tools 72 to access second end 120b. Second end 120b is then processed with one or more tools 72 to define features therefrom. When a rail is to be formed from shorter elongate work piece 110, second end 120b may be processed to form a tenon 122 and haunches 124 therefrom, as depicted by FIG. 15. In embodiments where shorter elongate work piece 110 is being processed to form a stile, second end 120b and, optionally, a corner 180b between second end 120b and front surface 160f may be shaped, or molded.

As illustrated by FIG. 13, the shorter elongate work piece 110 may be placed in another zone 40 of woodworking machine 10 to define features from one or both edges 140 and/or from front surface 160f. As an example, in zone 40, shorter elongate work piece 110 may be oriented against support 20 such that interior edge 140i and front surface 160f are located along working edge 41 (e.g., by placing at least one end 120 of shorter elongate work piece 110 against a side fence 42, (44, FIGS. 1 through 3) and at least one edge 140 or surface 160 of shorter elongate work piece 110 against a stop 33c, 33d, etc., adjacent to working edge 41). With shorter elongate work piece 110 positioned adjacent to working edge 41 and stops 33c, 33d, etc., moved out of the way, tools 72 (FIGS. 4 and 5) may access interior edge 140i to process the same. Without limiting the scope of the present invention, various tools 72 may form a groove 144 along the length of interior edge 140i, as shown in FIG. 16. In some embodiments, molded features (e.g., a corner bead, etc.) may also be formed along an interior corner 180i between interior edge 140i and front surface 160f. In embodiments where shorter elongate work piece 110 is being processed to form a stile, mortises 142 (which are configured to receive tenons 122 and haunches 124) may also be formed at selected locations along interior edge 140i. Additionally (e.g., in embodiments where woodworking machine 10 includes shaping tools 72 that are oriented perpendicular to the plane in which a supported surface of shorter elongate work piece 110 resides when shorter elongate work piece 110 is held by support 20), molded features may be formed on front surface 160f while shorter elongate work piece 110 remains in the illustrated orientation (i.e., joint features and shaping processes may be effected substantially concurrently). Alternatively (e.g., in embodiments where the shaping tools 72 of woodworking machine 10 are parallel to the plane in which a supported surface or shorter elongate work piece 110 is located), shorter elongate work piece 110 may be rotated to an orientation in which front surface 160f faces tools 72 before front surface 160f is processed.

In some embodiments, such as that shown in FIG. 14, the shorter elongate work piece may be (re)oriented within zone 40 (e.g., with an opposite edge 140e adjacent to working edge 41 of support 20) so that additional features may be formed on the opposite edge 140e. In embodiments where a center rail is being formed from shorter elongate work piece 110, another groove, additional mortises 142, and/or shaped, or molded, features may be defined in opposite edge 140e. In embodiments where a top or bottom rail is being formed from shorter elongate work piece 110, opposite edge 140e may be shaped, or molded. In addition, front surface 160f and/or an exterior corner 180e between front surface 160f and opposite edge 160e may also be processed to shape, or mold, the same (i.e., joint features and shaping processes may be effected substantially concurrently).

Shorter elongate work pieces 110 may be positioned and oriented manually, or with automated (e.g., robotic) handling equipment.

Although the foregoing description contains many specifics, these should not be construed as limiting the scope of the present invention, but merely as providing illustrations of some embodiments. Similarly, other embodiments of the invention may be devised which do not exceed the scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

What is claimed:

1. A method for preserving wood while processing an elongate work piece, comprising:
inspecting a rough elongate work piece;
positioning the rough elongate work piece relative to a support of a machine in a selected orientation based upon inspection of the work piece;
securing the elongate work piece to the support in the selected orientation; and
defining features from at least one of an end, an edge, and a major surface of the rough elongate work piece.

2. The method of claim 1, wherein positioning comprises positioning a major surface of the rough work piece that includes at least one undesirable feature against the support of the machine.

3. The method of claim 1, wherein positioning comprises positioning a major surface with desirable features facing away from the support of the machine.

4. The method of claim 1, wherein defining features comprises defining features in an edge of the rough work piece that reduce a number of visible undesirable features in the edge.

5. A method for optimizing efficiency in wood machining processes, comprising:
inspecting a long, elongate work piece to identify imperfections in the long, elongate work piece;
cutting shorter elongate work pieces from the long, elongate work piece based on the act of inspecting; and
shaping the shorter elongate work pieces after the act of cutting.

6. The method of claim 5, further comprising:
defining joint features from the shorter elongate work pieces.

7. The method of claim 6, wherein shaping and defining are effected substantially concurrently.

8. The method of claim 6, further comprising:
inspecting surfaces of the shorter elongate work piece before shaping and defining.

9. The method of claim 8, further comprising:
selecting surfaces on which the acts of shaping and defining are to be effected based on the act of inspecting surfaces of the shorter elongate work piece.

10. The method of claim 9, wherein selecting surfaces comprises selecting surfaces that are substantially free of defects for shaping.

11. The method of claim 9, wherein selecting surfaces comprises selecting surfaces that include defects for defining.

12. The method of claim 11, wherein defining includes at least partially removing at least some of the defects.

13. A woodworking machine, comprising:
a single frame;
a support carried by the single frame and including:
at least one first zone at which ends of an elongate work piece are shaped or machined to form joint features therefrom; and
at least one second zone laterally adjacent to the at least one first zone, at which edges of the elongate work piece are machined to form joint features therefrom, and at which at least one of an edge and a surface of the elongate work piece is shaped; and
at least one tool assembly carried by the single frame, translatable along the support, and including tools for machining and shaping the elongate work piece.

14. The machine of claim 13, wherein the at least one first zone includes a first section for receiving a first rough work piece in a first orientation and at least a second zone for receiving a second rough work piece in a second orientation.

15. The machine of claim 14, wherein operation of the tool assembly alternates between the first section and the second section.

16. The machine of claim 13, comprising a plurality of tool assemblies, including at least one first tool assembly dedicated to the at least one first zone and at least one second tool assembly dedicated to the at least one second zone.

17. The machine of claim 13, comprising at least to second zones.

18. The machine of claim 13, wherein the at least one second zone is configured to be subdivided into a plurality of subzones.

19. The machine of claim 13, further comprising:
automated handling equipment for positioning and orienting rough work pieces at the at least one first zone and the at least one second zone and for moving rough work pieces between the at least one first zone and the at least one second zone.

20. A method for forming a complex curve in or from a work piece, comprising:
defining a customized curve including a plurality of arcs joined by smooth transitions; and
causing a woodworking machine to form the customized curve in or from a work piece.

21. The method of claim 20, wherein defining the customized curve includes:
defining a central arc of the customized curve;
defining at least one pair of side arcs of the customized curve; and
smoothing transitions between ends of the central arc and adjacent ends of the side arcs.

22. The method of claim 21, wherein smoothing transitions comprises defining the central arc and defining the at least one pair of side arcs such that tangents to each end of the central arc and ends of the side arcs that are common to each end of the central arc are also common.

23. The method of claim 22, wherein smoothing transitions comprises limiting available options for at least one of the central arc and the side arcs.

24. The method of claim 22, wherein smoothing transitions comprises modifying at least one of the central arc and the at least one pair of side arcs while defining the other of the at least one pair of side arcs and the central arc.
